(19) United States
(12) Patent Application Publication
(10) Pub. No.: US 2022/0199319 A1
(43) Pub. Date: Jun. 23, 2022

(54) SYSTEM FOR TRANSMITTING ELECTRICAL ENERGY

(71) Applicant: FOLQUER HOLDINGS LIMITED, Nicosia (CY)

(72) Inventors: Andrey Borisovich TARASOV, Moscow (RU); Oleg Vladimirovich TRUBNIKOV, Moscow (RU); Konstantin Victorovich SAPRYKIN, Moscow (RU)

(21) Appl. No.: 17/542,109

(22) Filed: Dec. 3, 2021

(30) Foreign Application Priority Data
Dec. 18, 2020 (RU) 2020142015

(51) Int. Cl. H01F 38/14

(52) U.S. Cl. CPC H01F 38/14

(57) ABSTRACT

Provided is a system for transmitting electrical energy comprising: transmitting and receiving quarter-wave resonant transformers, the quarter-wave winding of each of which is provided with contact terminals; a source of electrical energy connected to a coupling coil configured to establish a magneto-inductive link with the quarter-wave winding of the transmitting transformer with providing the possibility of exciting resonant oscillations in the quarter-wave winding of the transmitting transformer; a receiver of electrical energy connected to a coupling coil configured to establish a magneto-inductive link with the quarter-wave winding of the receiving transformer with providing the possibility of receiving electrical energy from the quarter-wave winding of the receiving transformer; an electrical energy transmission line connecting inter se the low-potential portions of the quarter-wave windings of said receiving and transmitting transformers so as to transmit electrical energy therebetween with providing the possibility of exciting resonant oscillations in the quarter-wave winding of the receiving transformer, wherein a sliding contact is connected to the high-potential terminal of each of said quarter-wave transformers, the sliding contact being configured to move along the quarter-wave winding of the quarter-wave transformer with providing the possibility of connecting to one of the contact terminals thereof.

### FIELD OF INVENTION

The present technical solution relates to electrical engineering, specifically to systems for transmitting electrical energy using resonant techniques between stationary objects, and between stationary power sources and movable devices that receive electrical energy.

### BACKGROUND OF INVENTION

Known are a method and system for transmitting electrical energy over long distances via a single-wire electrical energy transmission line, which were developed by Nikola Tesla and disclosed in U.S. Pat. No. 593,138 (published on Nov. 2, 1897) and U.S. Pat. No. 645,576 (published on Mar. 20, 1900).

In particular, according to N. Tesla's inventions, the system consists of two (transmitting and receiving) resonant transformers with resonant step-up windings, which are single-layer spiral quarter-wave segments of long lines on cylindrical formers, and a conductor connecting the high-potential terminals of the resonant step-up windings. The low-potential terminals of the resonant quarter-wave windings of the both transformers are grounded immediately near the transformer structures. The low-voltage winding of the transmitting transformer is connected to the output of an elevated-frequency generator, which is the converter of source energy into alternating current electrical energy having a frequency that is equal to the resonant frequency of a resonant single-wire system for transmitting electrical energy. The low-voltage winding of the receiving transformer is connected to the energy-consuming load.

Connecting one of the terminals of the single-layer high-voltage spiral windings to earth, and the other terminals of these windings to a wire connecting the high-voltage terminals of the helical windings, results in creation of conditions for the occurrence of standing waves of electromagnetic oscillations of electrical current along the high-voltage windings with a wavelength of about 4 times the length of each of the resonant high-voltage helical windings.

λ=4·l

Here: λ is the length of a standing wave in the system for transmitting electrical energy;

l is the length of the helical high-voltage winding of the N. Tesla's transformer.

One-half of a standing wave of a resonant oscillation rests along the entire transmission system, i.e. from the grounded low-potential terminal of the high-voltage helical winding of the transmitting resonant transformer along the resonant winding, as well as the single-wire line conductor connecting the high-potential terminals of the high-voltage windings of the transmitting and receiving transformers along the high-voltage resonant winding of the receiving transformer up to the grounded low-potential terminal of the receiving transformer.

$$\frac{λ}{2} = 2 \cdot l + L$$

Here: L is the distance between the resonant transformers.

The standing wave mode is characterized by the fact that the amplitudes of current and voltage oscillations vary in intensity along the system for transmitting electrical energy. Regions with increased and decreased currents and potentials are formed in the system. The system's regions with maximum current or potential swings are referred to as current or potential antinodes, the regions with minimum or zero amplitudes are referred to as current or potential nodes.

In the N. Tesla's transmission system, the potential antinode is formed at the high-potential terminals of transmitting and receiving quarter-wave transformers and a single-wire electrical energy transmission line. The current node is disposed here as well. Current antinodes are produced on the low-potential portions and terminals of quarter-wave transformers and in the grounding connections of low-potential terminals thereof.

Disposing a current node on the transmitting line significantly reduces the current in the electrical energy transmission line, which fact contributes to sharply reduced losses during energy transmission and is an advantage of the method. A disadvantage of the known method for transmission of electrical energy is high susceptibility to degradation of the wave transmission mechanism under increased transmission distance. Further, the capacitance of the ground conductor of the transmission line is increased. The capacitance of the ground conductor of the transmission line is eventually connected in parallel with the quarter-wave windings of the resonant transformers. When the capacitance of the transmitting ground conductor reaches the ground capacitance of the resonant windings, the transformer loses wave properties, and, therefore, the potential and current antinodes and nodes disappear. The effects of capacitive short-circuiting are even more intense in the case of transmission of energy via a line configured as a cable. Another disadvantage of the known method is high Joule losses in the grounding connections, since antinodes of standing waves of current form therein.

Thus, there is an obvious need for further improvement of systems for transmitting electrical energy, in particular, to preserve the wave effect in such systems when transmitting electrical energy over different distances.

Accordingly, one of the technical problems solved by the present technical solution is to create a system for transmitting electrical energy, wherein the above disadvantages of the known solutions, which disadvantages consist in the impossibility of preserving the wave effect when transmitting electrical energy over different distances, are at least partially eliminated.

### DISCLOSURE OF ESSENCE

The present technical solution solves the above technical problem due to the fact that the proposed system for the transmission of electrical energy comprises:

transmitting and receiving quarter-wave resonant transformers, the quarter-wave winding of each of which is provided with contact terminals,

a source of electrical energy connected to a coupling coil configured to establish a magneto-inductive link with the quarter-wave winding of the transmitting transformer with providing the possibility of exciting resonant oscillations in the quarter-wave winding of the transmitting transformer,

a receiver of electrical energy connected to a coupling coil configured to establish a magneto-inductive link with the quarter-wave winding of the receiving transformer with providing the possibility of receiving electrical energy from the quarter-wave winding of the receiving transformer,

an electrical energy transmission line connecting inter se the low-potential portions of the quarter-wave windings of said receiving and transmitting transformers so as to transmit electrical energy therebetween with providing the possibility of exciting resonant oscillations in the quarter-wave winding of the receiving transformer, wherein

a sliding contact is connected to the high-potential terminal of each of said quarter-wave transformers, the sliding contact being configured to move along the quarter-wave winding of the quarter-wave transformer with providing the possibility of connecting to one of the contact terminals thereof.

The subject system for transmitting electrical energy provides a technical result represented by increased efficiency of the transmission of electrical energy by way of reducing electrical losses and enabling more accurate and flexible adjustment of the frequency and operating modes of the system. In one of the embodiments of the present technical solution, the source of electrical energy may be an alternating current source, and the receiver of electrical energy may be a direct current receiver, wherein said receiver may be connected to the coupling coil on the side of the receiving quarter-wave transformer by means of an alternating current to direct current converter.

In another embodiment of the present technical solution, the source of electrical energy may be a direct current source, and the receiver of electrical energy may be an alternating current receiver, wherein said source may be connected to the coupling coil on the side of the transmitting quarter-wave transformer by means of a direct current to alternating current converter.

In yet another embodiment of the present technical solution, the source of electrical energy may be a direct current source, and the receiver of electrical energy may be a direct current receiver, wherein said source may be connected to the coupling coil on the side of the transmitting quarter-wave transformer by means of a direct current to alternating current converter, and said receiver may be connected to the coupling coil on the side of the receiving quarter-wave transformer by means of an alternating current to direct current converter.

In some other embodiment of the present technical solution, the coupling coil on the side of the transmitting quarter-wave transformer may have taps intended for connecting to an electrical energy source and may be provided with a slider configured to move along the turns of said coupling coil with providing the possibility of connecting to one of said taps.

In another embodiment of the present technical solution, the coupling coil on the side of the receiving quarter-wave transformer may have taps for connecting to an electrical energy receiver and may be provided with a slider configured to move along the turns of said coupling coil with providing the possibility of connecting to one of said taps.

In some embodiments of the present technical solution, a further sliding contact configured to move along the turns of the low-potential portion of the quarter-wave winding of the transformer may be connected to the low-potential terminal in each of the transmitting and receiving quarter-wave transformers by means of a grounded capacitor.

In some other embodiments of the present technical solution, to connect the high-potential terminal of each of the transmitting and receiving quarter-wave transformers to the corresponding one of the sliding contacts, a corresponding capacitor of predetermined capacitance may be used.

In other embodiments of the present technical solution, to connect the high-potential terminal of each of the transmitting and receiving quarter-wave transformers to the corresponding one of the sliding contacts, a corresponding capacitor of variable capacitance may be used.

In some other embodiments of the present technical solution, the high-potential terminal in each of the transmitting and receiving quarter-wave transformers may be further connected to a solitary capacitor.

According to one of the embodiments of the present technical solution, each of the transmitting and receiving transformers may be a quarter-wave resonant Tesla transformer.

### BRIEF DESCRIPTION OF DRAWINGS

The attached drawings, which are provided for a better understanding of the essence of the present utility model, are an integral part hereof and are included herein to illustrate the below embodiments of the present utility model. The attached drawings, in combination with the description below, are intended to explain the essence of the present utility model. In the drawings:

FIG. 1 shows a block diagram of one of the embodiments of the system for transmitting electrical energy according to the present technical solution;

FIG. 2 shows a block diagram of another embodiment of the system for transmitting electrical energy according to the present technical solution;

FIG. 3 shows a block diagram of another embodiment of the system for transmitting electrical energy according to the present technical solution;

FIG. 4 shows a block diagram of another embodiment of the system for transmitting electrical energy according to the present technical solution;

FIG. 5-11 show block diagrams for the embodiments of the system for the transmission of electrical energy according to FIG. 2 with control and measurement equipment for testing the technical parameters of the system with the sliding contacts of the transformers not used and with various connections of the electrical energy transmission line to the contact terminals of the transformers;

FIG. 12-21 show block diagrams for other embodiments of the system for transmitting electrical energy according to FIG. 2 with control and measurement equipment for testing the technical parameters of the system with various connections of the sliding contacts of the transformers to the contact terminals of the transformers and with various connections of the electrical energy transmission line to the contact terminals of the transformers;

FIG. 22-24 show block diagrams for yet other embodiments of the system for transmitting electrical energy according to FIG. 2 with control and measurement equipment for testing the technical parameters of the system with the sliding contacts of the transformers not used, with the same connection of the electrical energy transmission line to the contact terminals of the transformers and with a different number of turns of the transformers.

### IMPLEMENTATION

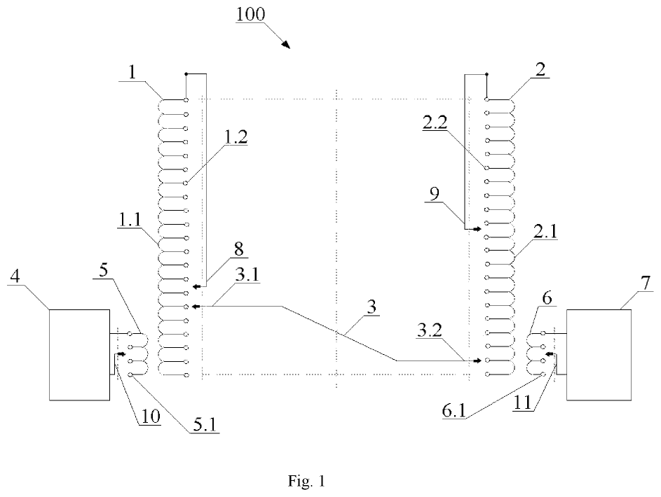

FIG. 1 shows a block diagram of the system 100 for transmitting electrical energy according to the present technical solution. The system 100 shown in FIG. 1 may be used to transmit electrical energy over a predetermined distance, including over long distances of more than 1000 km. Those skilled in the art will appreciate that the system 100 may be used to transmit electrical energy over any target distance, which may be, for example, from 0.5 meters to 40,000 km.

The system 100 comprises two resonant circuits, one of which is defined by a quarter-wave resonant transformer 1, and the other resonant circuit is defined by a quarter-wave resonant transformer 2, wherein the quarter-wave resonant transformers are electrically connected to each other by means of a single-wire electrical energy transmission line 3. It should be noted that the quarter-wave resonant transformer 1 may be configured as, for example, a quarter-wave resonant Tesla transformer and may function, in the system 100, as a transmitting transformer; the quarter-wave resonant transformer 2 may be configured as, for example, a quarter-wave resonant Tesla transformer and may function, in the system 100, as a receiving transformer. In a preferred embodiment of the present technical solution, the system 100 may use generally identical receiving and transmitting quarter-wave resonant Tesla transformers 1, 2 having generally identical design peculiarities of the winding and generally identical technical parameters.

In one of the embodiments of the present technical solution, the quarter-wave resonant transformers 1, 2 may each be configured as a quarter-wave resonant Tesla transformer, wherein the quarter-wave resonant Tesla transformer 1 may function, in the system 100, as a receiving transformer and have the design peculiarities and operating peculiarities described below in relation to the receiving resonant Tesla transformer, and the quarter-wave resonant Tesla transformer 2 function, in the system 100, as a transmitting transformer and have the design peculiarities and operating peculiarities described below in relation to the transmitting resonant Tesla transformer.

In another embodiment of the present invention, the quarter-wave resonant transformers 1, 2 may each be configured as a modified transformer, which is a set of concentrated coils, or windings that are distributed along the length or height.

Those skilled in the art will appreciate that the system 100 may consist of any number of resonant transformers that operate in a mode that will be equivalent to two quarter-wave resonant transformers. It is understood herein that the quarter-wave resonant transformer 1 may be made of any number of transformers, and the quarter-wave resonant transformer 2 may be made of any number of transformers.

As shown in FIG. 1, the transmitting resonant transformer 1 has a quarter-wave winding 1.1 provided with taps or contact terminals 1.2, each extending from the corresponding one of the turns of the quarter-wave winding 1.1, and the receiving resonant transformer 2 also has a quarter-wave winding 2.1 provided with taps or contact terminals 2.2, each extending from the corresponding one of the turns of the quarter-wave winding 2.1. In one of the embodiments of the present technical solution, the contact terminals 1.1 may each extend from the corresponding one of the winding sections (not shown), into which the quarter-wave winding 1.1 of the transformer is divided and each of which comprises a predetermined number of winding turns, for example, two or more winding turns, and the contact terminals 2.1 may each extend from the corresponding one of the winding sections (not shown), into which the quarter-wave winding 2.1 of the transformer is divided and each of which comprises a predetermined number of winding turns, for example, two or more winding turns. In another embodiment of the present technical solution, the quarter-wave winding 1.1 in the transmitting resonant transformer 1 and the quarter-wave winding 2.1 in the receiving resonant transformer 2 may be configured as a set of sections of concentrated coils distributed along the length or height of the resonant transformers 1 and 2.

Those skilled in the art will appreciate that resonant transformers 1 and 2 are resonant circuits with distributed parameters and do not necessarily have to be configured as transformers, but may be configured as a single coil with distributed parameters or made from a set of two or more coils with concentrated parameters that are distributed in space.

Furthermore, as shown in FIG. 1, the system 100 comprises a tunable coupling coil 5 (also referred to in the prior art as a pump coil) provided with contact terminals or taps 5.1, each extending from the corresponding one of the turns of the coupling coil 5, and configured to establish a magneto-inductive link with the quarter-wave winding 1.1 of the transmitting resonant transformer 1 with providing the possibility to excite resonant oscillations in the quarter-wave winding 1.1, and a tunable coupling coil 6 provided with contact terminals or taps 6.1, each extending from the corresponding one of the turns of the coupling coil 6, and configured to establish a magneto-inductive link with the quarter-wave winding 2.1 of the receiving resonant transformer 2 with providing the possibility to receive electrical energy by the quarter-wave winding 2.1 from the coupling coil 6.

It should be noted that the tunable coupling coil 5 may be tuned using a sliding contact or slider 10 configured to move along the turns of the coupling coil 5 with providing the possibility of connecting to one of the taps 5.1, which allows to adjust or tune the actual parameters of the coupling coil 5 in the operating or design mode thereof. Similarly, the tunable coupling coil 6 may be tuned using a sliding contact or slider 11 configured to move along the turns of the coupling coil 6 with providing the possibility of connecting to one of the taps 6.1, which allows to adjust or tune the actual parameters of the coupling coil 6 in the operating mode thereof. In particular, moving the slider 10 with the provision of the connection thereof to one of the taps 5.1 provides the possibility to modify or tune the inductance (self-induction coefficient) of the coupling coil 5, which, inter alia, depends on the number of turns of the coil and which is essentially the main electrical parameter of the coupling coil 5, characterizing the amount of electrical energy that the coupling coil 5 can store when an electric current flows therethrough (the greater the inductance of the coupling coil 5, the more electrical energy it stores in the magnetic field thereof), and moving the slider 11 with the provision of the connection thereof to one of the taps 6.1 in the same fashion provides the possibility to modify or tune the inductance (self-induction coefficient) of the coupling coil 5.

It should further be noted that the coupling coil 5 and the coupling coil 6 each essentially functions as a bandpass filter, providing the necessary coupling coefficient and, consequently, the necessary transformation coefficient in the corresponding resonant transformer.

Thus, the slider 10 and the slider 11 substantially allow using not all the inductance of the coupling coil 5 and the coupling coil 6, respectively, in their operating modes, but only a certain portion thereof, depending on the desired task.

It should further be noted that each of the coupling coils 5, 6 and quarter-wave windings 1.1, 2.1 of the transformers has its own capacity or parasitic (linear) capacity, which increases with the increase of the number of turns and their design. In particular, there is an inter-turn capacitance between adjacent or neighboring turns, due to which some portion of the current passes through the capacitance between the turns, which leads to a decrease in the resistance between the terminals in each of the coupling coil 5, coupling coil 6, transformer winding 1.1 or transformer winding 2.1. This is due to the fact that the total voltage applied to the coupling coil 5, the coupling coil 6, the transformer winding 1.1 or the transformer winding 2.1 is essentially divided into inter-turn voltages, which causes the generation of an electric field between the turns, which causes the accumulation of charges, wherein the turns, separated by insulation layers, substantially form the plates of many small capacitors, through which a portion of the current flows and from the total capacity of which the self-capacitance of the coupling coil 5, the coupling coil 6, the transformer winding 1.1 or the transformer winding 2.1 is composed. Thus, the coupling coil 5, the coupling coil 6, the transformer winding 1.1 and the transformer winding 2.1 each have not only inductive properties, but also capacitive properties, which depend on the type of design and technical specifications thereof.

As shown in FIG. 1, the primary or low-potential terminal of the quarter-wave winding 1.1 in the transmitting resonant transformer 1 is isolated and left unconnected, and the slider or sliding contact 8 configured to move along the quarter-wave winding 1.1 providing the possibility of connecting to one of the contact terminals 1.2 thereof is connected, by means of a corresponding conductor, to the secondary or high-potential terminal of the quarter-wave winding 1.1. Similarly, the primary or low-potential terminal of the quarter-wave winding 2.1 in the receiving resonant transformer 2 is isolated and left unconnected, and the slider or sliding contact 8 configured to move along the quarter-wave winding 2.1 providing the possibility of connecting to one of the contact terminals 2.2 thereof is connected, by means of a corresponding conductor, to the secondary or high-potential terminal of the quarter-wave winding 2.1.

Furthermore, as shown in FIG. 1, the system 100 further comprises a source 4 of electrical energy on the transmitting side thereof characterized by the presence of a transmitting resonant transformer 1, and a receiver 7 of electrical energy on the receiving side thereof characterized by the presence of a receiving resonant transformer 2. The source 4 of electrical energy is serially connected to the coupling coil 5 with the possibility of applying voltage thereto, and the receiver 7 of electrical energy is serially connected to the coupling coil 6 with the possibility of receiving electrical energy therefrom.

In the preferred embodiment of the present technical solution, the source 4 of electrical energy is one of the sources of alternating current provided in the prior art, which is configured to output or supply alternating current (AC) voltage to the coupling coil 5, and the receiver 7 of electrical energy is one of the receivers of alternating current electrical energy provided in the prior art, which is configured to consume or accumulate alternating current (AC) electrical energy output by the coupling coil 6 to said receiver 7.

In one of the embodiments of the present technical solution, the source 4 of electrical energy may be one of the prior art sources of alternating current electrical energy configured to output or supply alternating current (AC) voltage to the coupling coil 5, and the receiver 7 of electrical energy may be one of the prior art receivers of direct current electrical energy configured to consume or accumulate direct current (DC) electrical energy. In this embodiment, the source 4 of electrical energy may be connected directly to the coupling coil 5 on the side of the transmitting resonant transformer 1, and the electrical energy receiver 7 must be connected to the coupling coil 6 on the side of the receiving resonant transformer 2 by means of an alternating current to direct current converter (not shown), which converts alternating current electrical energy received from the coupling coil 6 into direct current electrical energy consumed by the electrical energy receiver 7.

In yet another embodiment of the present technical solution, the source 4 of electrical energy may be one of the prior art sources of direct current electrical energy, configured to output direct current (DC) voltage, and the receiver 7 of electrical energy may also be one of the prior art receivers of alternating current electrical energy, configured to consume or accumulate alternating current (AC) electrical energy. In this embodiment, the electrical energy source 4 must be connected to the coupling coil 5 on the side of the transmitting resonant transformer 1 by means of a direct current to alternating current converter (not shown), which converts direct current electrical energy output by the electrical energy source 4 into alternating current electrical energy supplied to the coupling coil 5, and the electrical energy receiver 7 may be connected directly to the coupling coil 6 on the side of the receiving resonant transformer 2.

In another embodiment of the present technical solution, the source 4 of electrical energy may be one of the prior art sources of direct current electrical energy, configured to output direct current (DC) voltage, and the receiver 7 of electrical energy may also be one of the prior art direct current (DC) electrical energy receivers configured to consume or accumulate direct current (DC) electrical energy. In this embodiment, the electrical energy source 4 must be connected to the coupling coil 5 on the side of the transmitting resonant transformer 1 by means of a direct current to alternating current converter (not shown), which converts the direct current electrical energy output by the electrical energy source 4 into alternating current electrical energy supplied to the coupling coil 5, and the electrical energy receiver 7 must be connected to the coupling coil 6 on the side of the receiving resonant transformer 2 by means of an alternating current to direct current converter (not shown), which converts alternating current electrical energy received from the coupling coil 6 into direct current electrical energy consumed by the electrical energy receiver 7.

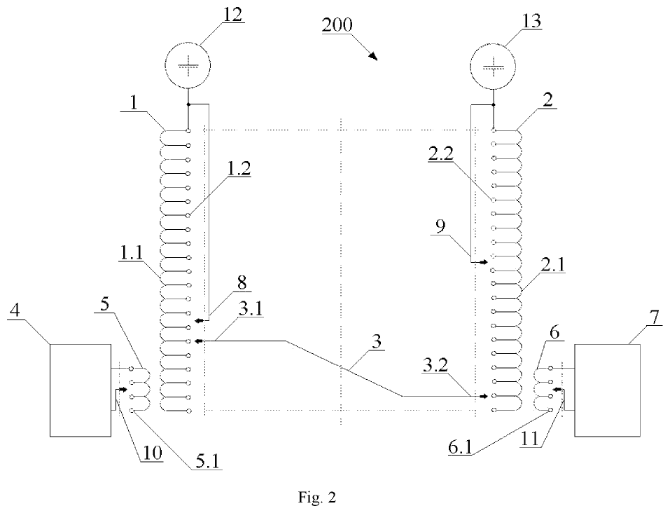

As shown in FIG. 2, the electrical energy source 4 is connected, by means of appropriate conductors, on the input side of the coupling coil 5, to two taps 5.1, between which the input voltage is supplied to the coupling coil 5, wherein one of the two conductors used to connect the electrical energy source 4 to the coupling coil 5 is provided with a slider 10 configured to move along the taps 5.1. Similarly, the electrical energy receiver 7 is connected, by means of appropriate conductors, on the output side of the coupling coil 6, to two taps 6.1, to which the output voltage of the coupling coil 6 is supplied, wherein one of the two conductors used to connect the electrical energy receiver 7 to the coupling coil 6 is provided with a slider 11 configured to move along the taps 6.1.

Thus, the slider 10 and the slider 11 each enable to adjust or tune the coupling coil 5 and the coupling coil 6, respectively, in particular, to adjust the number of turns thereof, which provides the setting of a desired coupling coefficient value, transformation coefficient (Q) value and bandwidth (if there are present reactive elements in the electrical energy source 4 and in the electrical energy receiver 7). It should be noted that changing the operating mode of the coupling coil 5 will lead to a change in internal resistance thereof, thus enabling to tune or adjust the coupling coefficient between the coupling coil 5 and the transformer winding 1.1 on the side of the transmitting resonant transformer 1, which have a magneto-inductive link between each other. Similarly, changing the operating mode of the coupling coil 6 will lead to a change in internal resistance thereof, thus enabling to tune or adjust the coupling coefficient between the coupling coil 6 and the transformer winding 2.1, which have a magneto-inductive link between each other, on the side of the receiving resonant transformer 2.

It should be noted that each of the coupling coil 5 and the coupling coil 6 may be made, for example, of turns of heavy copper wire, a copper tube (for example, a 6 mm copper tube or a large cross-section conductor) or a litz wire, wherein the number of turns of the coupling coil 5 or coil 6 is substantially less than that of the resonant transformer 1 and resonant transformer 2, respectively, as the resistance of the winding of the coupling coil 5 or the coupling coil 6 must be small in view of the possible flow of a large electrical current therethrough. Each of the quarter-wave winding 1.1 and quarter-wave winding 2.1 may have a length exceeding the diameter thereof by up to about 5 times or alternately may have a diameter exceeding the length thereof by up to about 5 times, wherein the diameter of the conductor for the winding is selected so as to, for example, obtain 1000 turns (in other embodiments of the present technical solution, each of the quarter-wave winding 1.1 and quarter-wave winding 2.1 may have from hundreds to thousands of turns). Each of the winding of the coupling coil 5 or coupling coil 6 may be made in the form of a flat spiral, a short helical winding, a conical winding or a concentrated winding.

It should also be noted that the coupling coil 5 and the coupling coil 6 substantially function as the primary winding in the resonant transformer 1 and the secondary winding in the resonant transformer 2, respectively, and the quarter-wave winding 1.1 and the quarter-wave winding 2.1 substantially function as the secondary winding in the resonant transformer 1 and the primary winding in the resonant transformer 2, respectively. As disclosed below, the primary and secondary windings in the resonant transformer 1 having a magneto-inductive link between each other form two interconnected oscillating circuits on the transmitting side in the system 100, and the primary and secondary windings in the resonant transformer 2 having a magneto-inductive link between each other form two interconnected oscillating circuits on the receiving side in the system 100 such that each of the resonant transformer 1 and resonant transformer 2 will not only efficiently transmit electrical energy from the primary winding thereof to the secondary winding thereof, providing the required output voltage at low currents, but also store electrical energy.

In particular, the coupling coil 5 has its inductance capable of resonating with the intrinsic (parasitic) capacitance of the coupling coil 5, which fact substantially allows the coupling coil 5 to function as a primary oscillating circuit or LC circuit (also referred to in the prior art as a tuned circuit or resonant circuit) on the transmitting side or on the side of the resonant transformer 1 in the system 100. Similarly, the coupling coil 6 has its inductance capable of resonating with the intrinsic (parasitic) capacitance of the coupling coil 6, which fact substantially allows the coupling coil 6 to function as a secondary oscillating circuit or LC circuit (also referred to in the prior art as a tuned circuit or resonant circuit) on the receiving side or on the side of the resonant transformer 2 in the system 100. It should be noted that the coupling coil 5 will substantially pump energy to the system 100, and the coupling coil 6 will substantially drain energy from the system 100.

Furthermore, the quarter-wave winding 1.1 has its linear inductance capable of resonating with the intrinsic (parasitic) capacitance of the winding, which fact substantially allows the quarter-wave winding 1.1 to function as a secondary oscillating circuit or LC circuit (also referred to in the prior art as a tuned circuit or resonant circuit) on the transmitting side or on the side of the resonant transformer 1 in the system 100. Similarly, the quarter-wave winding 2.1 also has its inductance capable of resonating with the intrinsic (parasitic) capacitance of the winding, which fact substantially allows the quarter-wave winding 2.1 to function as a primary oscillating circuit or LC circuit (also referred to in the prior art as a tuned circuit or resonant circuit) on the receiving side or on the side of the resonant transformer 2 in the system 100.

The primary oscillating circuit and the secondary oscillating circuit on the transmitting and receiving sides, i.e. on the side of the transmitting transformer 1 and on the side of the receiving transformer 2, in the system 100 are configured such that the primary oscillating circuit and the secondary oscillating circuit on the side of the transmitting transformer 1 resonate at the same frequency, i.e. have the same resonant frequency, and the primary oscillating circuit and the secondary oscillating circuit on the side of the receiving transformer 2 also resonate at the same frequency, i.e. have the same resonant frequency, wherein the resonant frequency on the side of the transmitting transformer 1 and the resonant frequency on the side of the receiving transformer 2 will substantially coincide or have the same values.

Thus, when the primary winding of the transmitting transformer 1 is fed with alternating current having a frequency equal to the resonant frequency of the secondary winding of said transformer 1, the voltage at the output of the transformer 1 may increase by tens or even thousands of times.

It should be noted that the movement of the slider 10 allows substantially not only to tune the input voltage on the transmitting transformer 1, but also to adjust the intrinsic (parasitic or linear) capacitance and inductance of the coupling coil 5 to ensure that the oscillation frequency of the primary oscillating circuit formed by the coupling coil 5 coincides with the resonant frequency of the secondary oscillating circuit formed by the quarter-wave winding 1.1.

Moving the sliding contact 8 along the quarter-wave winding 1.1 makes it possible to adjust (the adjustment including continuous or periodic adjustment) the ratio of turns between the secondary winding and the primary winding of the transmitting resonant transformer 1, which fact in turn enables to adjust the output voltage output by the transmitting resonant transformer 1 in very wide ranges at very small increments, obtaining an output voltage of alternating current of increased frequency. Furthermore, depending on the embodiment of the electrical energy source 4, moving the sliding contact 8 along the quarter-wave winding 1.1 allows substantially to pump the system 100 with providing the possibility of transmitting electrical energy from the transmitting resonant transformer 1 to the receiving resonant transformer 2 along the single-wire transmission line 3 disclosed below.

To excite the quarter-wave operation mode of the transmitting resonant transformer 1, the required wave resistance impedances are substantially also selected, which fact makes it possible to provide the required coupling coefficient between the coupling coil 5 functioning as the primary winding of the transmitting resonant transformer 1 and the winding 1.1 functioning as the secondary winding of the transmitting resonant transformer 1. Thus, to ensure proper operation of the transmitting side in the system 100, it is necessary to tune not only the frequency at which the transmitting resonant transformer 1 will operate, but also to tune the internal resistance in the system 100, wherein moving the sliding contact 8 between the high-potential and low-potential terminals of the winding 1.1 allows to adjust or select the operating frequency at which the transmitting resonant transformer 1 operates (in particular, moving the sliding contact 8 along the turns of the winding 1.1 towards the low-potential terminal thereof substantially results in an increased operating frequency of the transmitting resonant transformer 1, and moving the sliding contact 8 along the turns of the winding 1.1 towards the high-potential terminal thereof substantially results in a decreased operating frequency of the transmitting resonant transformer 1).

As shown in FIG. 1, the transmitting resonant transformer 1 is electrically connected to the receiving resonant transformer 2 by using a single-wire electrical energy transmission line 3 connecting the low-potential portions of the quarter-wave windings 1.1, 2.1, each corresponding to the portion of the winding from the middle or from the geometric center of the winding dividing the winding along the length bounded by the high-potential terminal on one side and the low-potential terminal on the other side into two generally equal parts and up to the low-potential terminal of the winding. It should be noted that the electrical energy transmission line 3 is provided with sliders 3.1, 3.2, each configured, at the corresponding one of the two opposite ends of said transmission line 3, to move along the corresponding one of the quarter-wave windings 1.1, 2.1, with providing the possibility of connecting to one of the contact terminals 1.2 or contact terminals 2.2. It should further be noted that the positioning or displacing the electrical power transmission line 3 relative to the ground performed by connecting the slider 3.1 to the corresponding one of the contact terminals 1.2 in the low-potential portion of the quarter-wave winding 1.1 and connecting the slider 3.2 to the corresponding one of the contact terminals 2.2 in the low-potential portion of the quarter-wave winding 2.1 allows to select the impedances of the transmitting side in the system 100, i.e. the side with the transmitting resonant transformer 1, and the receiving side in the system 100, i.e. the side with the receiving resonant transformer 1, wherein the displacement of the electrical energy transmission line 3 towards the ground, in particular, the movement of the slider 3.1, 3.2 along the windings 1.1, 2.1, respectively, towards the low-potential terminals thereof provides operation, on the low-potential wire corresponding to the electrical energy transmission line 3, of two quarter-wave resonators corresponding to the receiving and transmitting resonant transformers 1, 2, without exerting any influence on the operating frequency of the system 100. In such embodiment, the system 100 will be a low-potential system, in particular due to connecting the electrical power transmission line 3 to the low-potential portions of the windings 1.1, 2.1.

It should be noted that the movement of the sliders 3.1 and 3.2 along the contact terminals 1.2, 2.2, respectively, also allows to select required parameters of the system 100: from high-potential to “medium-potential” and from “medium-potential” to low-potential, with different modes: traveling wave mode, standing wave mode and hybrid wave mode. The traveling wave mode is characterized by the presence of only an incident wave propagating from the transmitting system to the receiving system. There is no reflected wave present. The power born by the incident wave is completely released in the load. In this mode, BU=0, |H|=0, Rtw=Rsw=1. The traveling wave mode is formed when connecting the sliders 3.1 and 3.2 at a closer distance to the respective geometric centers of the windings 1.1, 2.1 in the resonant transformers 1 and 2. The standing wave mode is characterized by the fact that the amplitude of the reflected wave is equal to that of the incident wave BU=AU, i.e. the energy of the incident wave is completely reflected from the receiving system and returned back to the transmitting system. In this mode, |H|=1, Rsw=∞, Rtw=0. The standing wave mode is formed when connecting the sliders 3.1 and 3.2 at a closer distance to the corresponding low-potential terminals of the windings 1.1, 2.1 in the resonant transformers 1 and 2. In the hybrid wave mode, the amplitude of the reflected wave satisfies the condition 0<BU<AU, i.e. a portion of the power of the incident wave is absorbed by the receiving system, and the remaining portion in the form of a reflected wave is returned back, which repeats n times, the number of “n” repeats depends on the Q-factor of the entire system. Thereby, 0<|H|<1, 1<Rsw<∞, 0<Rtw<1. The hybrid wave mode is formed when connecting the sliders 3.1 and 3.2 substantially between the corresponding low-potential terminals and the geometric centers of the windings 1.1, 2.1 in the resonant transformers 1 and 2.

When increasing the length or distance of the electrical power transmission line 3, there is typically observed a decrease in the frequency of the electrical current flowing through the electrical power transmission line 3, but due to the proper tuning of said frequency with providing the preservation of the wave effect in the system 100 and connection of the electrical power transmission line 3 to the low-potential portions of the windings 1.1, 2.1, there will be no significant frequency change when increasing the distance between the transmitting and receiving resonant transformers 1, 2 when transmitting electrical energy via the electrical energy transmission line 3, i.e. the frequency will not depend on the length or distance of the electrical energy transmission line 3.

When the electrical energy transmitted via the electrical energy transmission line 3 from the transmitting resonant transformer 1 to the receiving resonant transformer 2 feeds the primary winding of the receiving transformer 2, the primary winding being the quarter-wave winding 2.1, with an alternating electrical current having a frequency equal to the resonant frequency of the secondary oscillatory circuit of the transmitting resonant transformer 1 defined by the quarter-wave winding 1.1, which results in the excitation of resonant oscillations in the primary oscillatory circuit of the receiving transformer 2 defined by the quarter-wave winding 2.1 that is substantially the primary winding of the receiving transformer 2.

The movement of the sliding contact 9 along the quarter-wave winding 2.1 makes it possible to adjust (including continuously or periodically) the ratio of turns between the primary and secondary windings of the receiving resonant transformer 2, which in turn allows to adjust the voltage at the receiving resonant transformer 2 in very wide ranges and at very small increments, wherein the voltage at the output of the receiving resonant transformer 2 will also substantially consist of a high frequency sinusoidal alternating current.

It should be noted that the movement of the slider 11 substantially allows not only to tune the input voltage supplied to the electrical energy receiver 7, but also to adjust the intrinsic (parasitic or linear) capacitance and inductance of the coupling coil 6 with providing the required wave resistance of the secondary oscillatory circuit defined by the coupling coil 6 that is substantially a secondary winding of the receiving resonant transformer 2, coinciding with the resonant frequency of the primary oscillatory circuit defined by the quarter-wave winding 2.1.

To excite the quarter-wave operation mode of the receiving resonant transformer 2, the required wave resistance impedances are substantially also selected, which fact makes it possible to provide the required coupling coefficient between the winding 2.1 functioning as a primary winding of the receiving resonant transformer 2 and the coupling coil 6 functioning as a secondary winding of the receiving resonant transformer 2. Thus, to ensure proper operation of the receiving side in the system 100, it is necessary to tune not only the frequency at which the receiving resonant transformer 2 will operate, but also to tune the internal resistance in the system 100, wherein moving the sliding contact 9 between the high-potential and low-potential terminals of the winding 2.1 allows to adjust or select the operating frequency at which the receiving resonant transformer 2 operates (in particular, moving the sliding contact 9 along the turns of the winding 2.1 towards the low-potential terminal thereof substantially results in an increased operating frequency of the receiving resonant transformer 2, and moving the sliding contact 9 along the turns of the winding 2.1 towards the high-potential output thereof substantially results in a decreased operating frequency of the receiving resonant transformer 2), as well as electrical energy transmission modes (see note 1).

Thus, as follows from the above description of the operating peculiarities of the transmitting and receiving sides in the system 100 shown in FIG. 2, when fulfilling the condition f₀=f_{CB1}=f₁=f₂=f_{CB2} (where f₀ is the frequency of the electrical current at the output of the electrical current source 4; f_{CB1} is the resonant frequency of the primary oscillating circuit on the side of the transmitting resonant transformer 1, which is defined by the coupling coil 5 and which is substantially a power circuit for the transmitting resonant transformer 1; f₁ is the resonant frequency of the secondary oscillating circuit on the side of the transmitting resonant transformer 1, which is defined by the quarter-wave winding 1.1 and which is substantially a power circuit for the receiving resonant transformer 2; f₂ is the resonant frequency of the primary oscillating circuit on the side of the receiving resonant transformer 2, which is defined by the quarter-wave winding 2.1 and which is substantially a power circuit for the coupling coil 6; and f_{CB2} is the resonant frequency of the secondary oscillating circuit on the side of the receiving resonant transformer 2, which is defined by the coupling coil 6 and which is substantially a power circuit for the electrical energy receiver 7), said primary and secondary oscillating circuits on the transmitting side and said primary and secondary oscillating circuits on the receiving side in the system 100 operate in a resonant mode, wherein the primary oscillating circuit on the transmitting side defined by the coupling coil 5 and the secondary oscillating circuit on the receiving side defined by the coupling coil 6 in the system 100 operate in a resonance mode on lumped reactive components, and the secondary oscillating circuit on the transmitting side defined by the winding 1.1 and the primary oscillating circuit on the receiving side defined by the winding 2.1 operate in a resonance mode on the segments of the long lines with distributed reactive parameters such that the quarter-wave windings 1.1, 2.1 develop standing waves in the form of quarter-wave embodiments with the potential nodes on the low-potential terminals of the windings 1.1, 2.1.

FIG. 2 shows another embodiment of the system for transmitting electrical energy according to the present technical solution. In general, the system 200 shown in FIG. 2 is made and functions similarly to the above system 100 shown in FIG. 1, except that the system 200 further comprises a solitary capacitor 12, to which the secondary or high-potential terminal of the quarter-wave winding 1.1 is further connected via the high-potential terminal by means of an appropriate conductor, and a solitary capacitor 13, to which the secondary or high-potential terminal of the quarter-wave winding 2.1 is further connected via the high-potential terminal by means of an appropriate conductor, wherein the solitary capacitor 12 and the solitary capacitor 13 each have a predetermined capacitance.

It should be noted that each of the solitary capacitors 12, 13 in the system 200 may be made in the form of a smooth metal sphere or torus having curvilinear surfaces of a large area, which fact allows same to reduce the potential (electrical field) gradient at the high-potential terminal of the corresponding one of the quarter-wave windings 1.1, 2.1 of the transformer. Each of the solitary capacitors 12, 13 in the system 200 functions similarly to the corona ring, increasing the voltage threshold at which air discharges are produced, such as corona discharge and brush discharge. Thus, the suppression of premature air breakdown and the reduction of energy loss provided by each of the solitary capacitors 12, 13 in the system 200 makes it possible to increase the Q-factor of the transmitting and receiving resonant transformers 1, 2, respectively, as well as to increase the output voltage thereof at waveform peaks. In one of the embodiments of the present technical solution, a torus made of corrugated aluminum and having an outer diameter equal to or greater than the diameter of the quarter-wave winding 1.1 or the quarter-wave winding 2.1 may be used as each of the solitary capacitors 12, 13 in the system 200.

Furthermore, another significant difference between the system 200 and the above system 100 above is that, in the system 200, the linear inductance possessed by the quarter-wave winding 1.1 is capable of resonating with the total linear parasitic capacitance, which is the sum of the intrinsic (parasitic) capacitance of the winding and the capacitance of the solitary capacitor 12, which fact substantially allows the quarter-wave winding 1.1 to function as a secondary oscillatory circuit or LC circuit (also referred to in the prior art as a tuned circuit or resonant circuit) on the transmitting side or the side of the resonant transformer 1 in the system 200, and the linear inductance possessed by the quarter-wave winding 2.1 is capable of resonating with the total linear parasitic capacitance, which is the sum of the intrinsic (parasitic) capacitance of the winding and the capacitance of the solitary capacitor 13, which fact substantially allows the quarter-wave winding 2.1 to function as a primary oscillating circuit or LC circuit (also referred to in the prior art as a tuned circuit or resonant circuit) on the receiving side or the side of the resonant transformer 2 in the system 200.

The solitary capacitor 12 in the system 200 will substantially (insignificantly) facilitate the reduction of the resonance frequency on the secondary winding of the transmitting resonant transformer 1. In one of the embodiments of the present technical solution, a torus made of corrugated aluminum and having an outer diameter equal to or greater than the diameter of the quarter-wave winding 1.1 or the quarter-wave winding 2.1 may be used as each of the solitary capacitors 12, 13. The capacitance of the solitary capacitor 12 may substantially be set depending on the required power and parameters of the transmitting resonant transformer 1.

The solitary capacitor 13 in the system 200 will substantially facilitate the reduction of the resonance frequency on the primary winding of the transmitting resonant transformer 1, the primary winding being defined by the winding 2.1. In one of the embodiments of the present technical solution, a torus made of corrugated aluminum and having an outer diameter equal to or greater than the diameter of the quarter-wave winding 1.1 or the quarter-wave winding 2.1 may be used as each of the solitary capacitors 12, 13. The capacitance of the solitary capacitor 13 may substantially be set depending on the required power and parameters of the receiving resonant transformer 2.

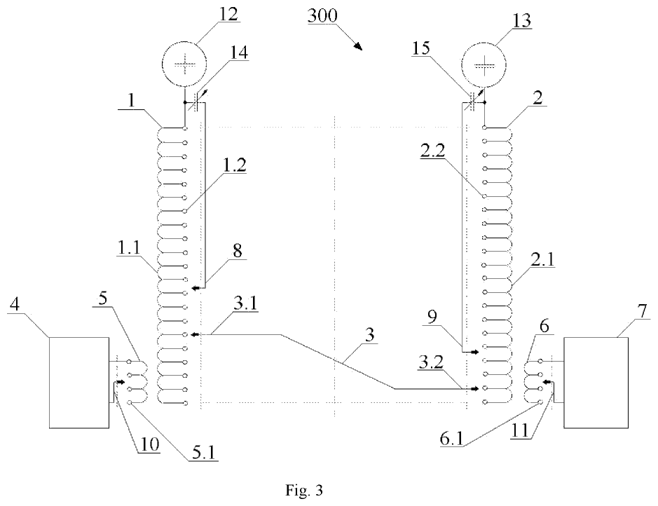

FIG. 3 shows another embodiment of the system for transmitting electrical energy according to the present technical solution. In general, the system 300 shown in FIG. 3 is made and functions similarly to the above system 100 shown in FIG. 2, except that the system 300 further comprises a variable capacitor 14, via which the sliding contact 8 is connected to the high-potential terminal of the quarter-wave winding 1.1, which is substantially the high-potential terminal of the transmitting resonant transformer 1, and a variable capacitor 15, via which the sliding contact 9 is connected to the high-potential terminal of the quarter-wave winding 2.1, which is substantially the high-potential terminal of the receiving resonant transformer 2. Adjusting the capacitance of the capacitor 14 and/or the capacitor 15 substantially provides a further possibility to adjust or tune the operating frequency of the system 300 on the transmitting side and receiving side thereof, respectively, with providing a small voltage adjustment on the transmitting resonant transformer 1 and receiving resonant transformer 2, respectively, which fact allows to improve the efficiency of the system 300 by more precise and flexible adjustment of the operating frequency of the system 300, in particular due to further adjustment or further tuning of the oscillation frequency in the high-potential portion of the system 300, which fact substantially allows to achieve potential resonance, thereby changing the operating mode of the high-potential portion of the system 300.

In one of the embodiments of the system 300 for transmitting electrical energy, shown in FIG. 3, the variable capacitor 14 and the variable capacitor 15 may be substituted with capacitors having a predetermined capacity pre-specified according to the required operating frequency parameters of the system 300 on the transmitting side and the receiving side, respectively.

In another embodiment of the system 300 for transmitting electrical energy, shown in FIG. 3, there may be provided no solitary capacitors 12, 13, wherein the sliding contact 8 may be connected to the high-potential terminal of the quarter-wave winding 1.1 via the capacitor 14, which may have a variable capacitance or a predetermined capacitance, and the sliding contact 9 may be connected to the high-potential terminal of the quarter-wave winding 2.1 via the capacitor 15, which may have a variable capacitance or a predetermined capacitance.

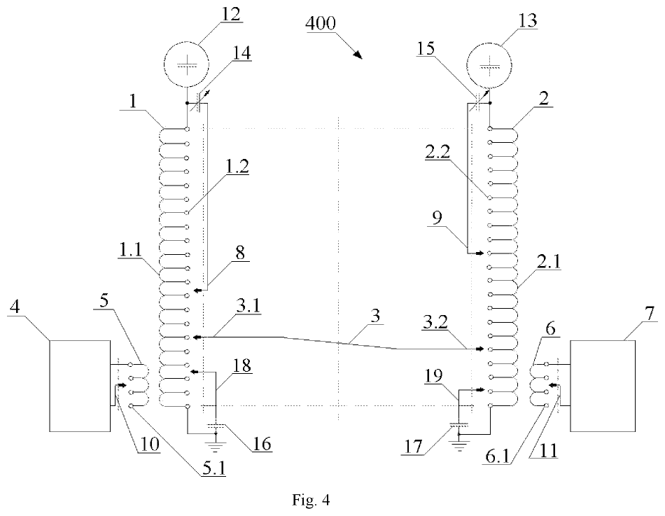

FIG. 4 shows another embodiment of the system for transmitting electrical energy according to the present technical solution. In general, the system 400 shown in FIG. 4 is made and functions similarly to the above system 300 shown in FIG. 3, except that the system 400 further comprises a grounded capacitor 16, via which a sliding contact 18 is further connected to the low-potential terminal of the quarter-wave winding 1.1, the sliding contact 18 being configured to move along the turns of the low-potential portion of the quarter-wave winding 1.1, and a grounded capacitor 17, via which a sliding contact 19 is further connected to the low-potential terminal of the quarter-wave winding 2.1, the sliding contact 19 being configured to move along the turns of the low-potential portion of the quarter-wave winding 2.1. Thus, in fact, in the system 400, the capacitor 16 is closed onto the transmitting resonant transformer 1 and further grounded, and the capacitor 17 is closed onto the receiving resonant transformer 2 and further grounded. Such a further functional unit defined by the sliding contact 18 connected by one of the ends thereof, by means of the grounded capacitor 16, to the low-potential terminal of the quarter-wave winding 1.1 in the low-potential portion of the transmitting resonant transformer 1 and a further functional unit defined by the sliding contact 19 connected by one of the ends thereof, by means of the grounded capacitor 17, to the low-potential terminal of the quarter-wave winding 2.1 in the low-potential portion of the receiving resonant transformer 2 make it possible to adjust the oscillation frequency in the low-potential portion of the system 400 to achieve a current resonance, thereby changing the operating mode of the low-potential portion of the system 400. Simultaneous or parallel change in the operating mode of the high-potential portion of the system 400 and the operating mode of the low-potential portion of the system 400 allow to establish the desired balance in the operation of the system 400, thereby significantly increasing the efficiency of operation of the system 400 due to a more precise and flexible adjustment of the system 400.

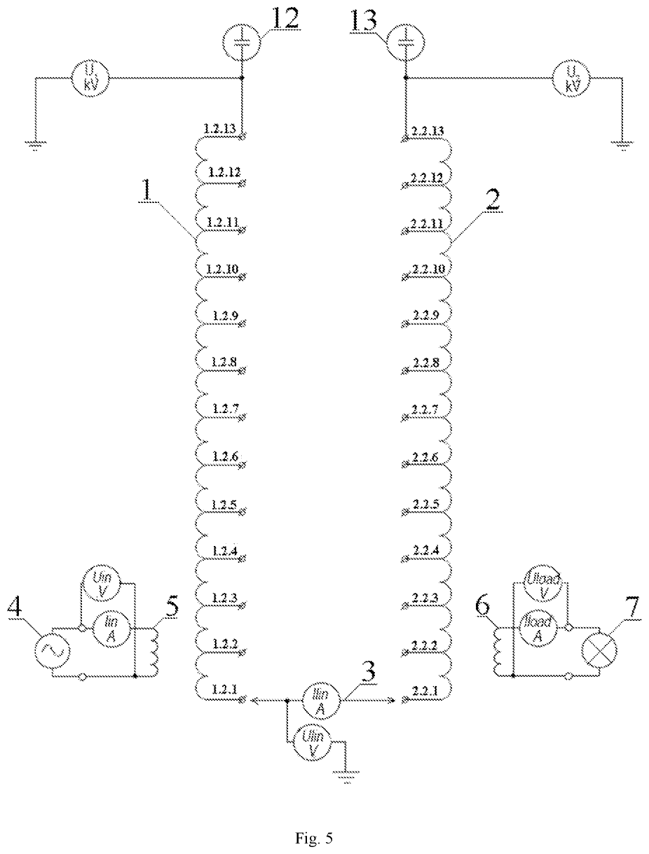

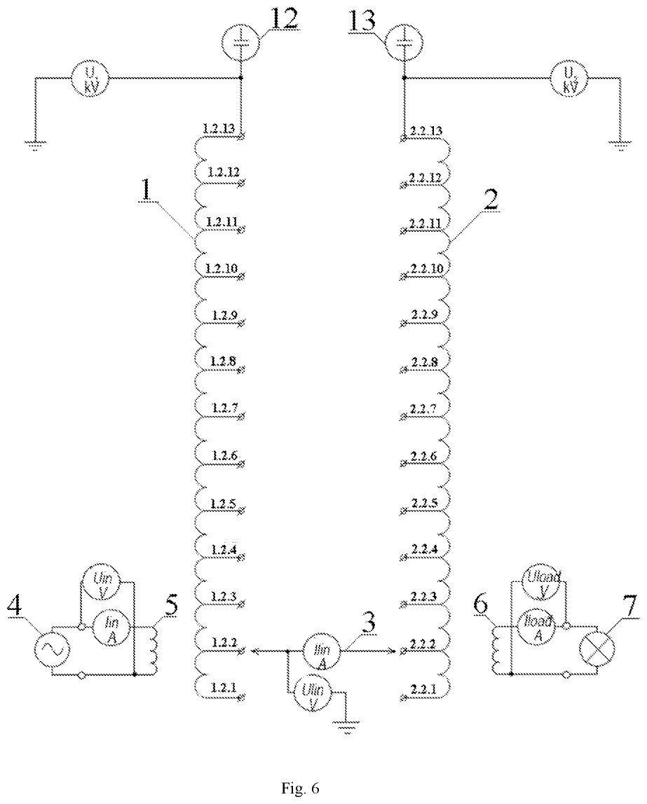

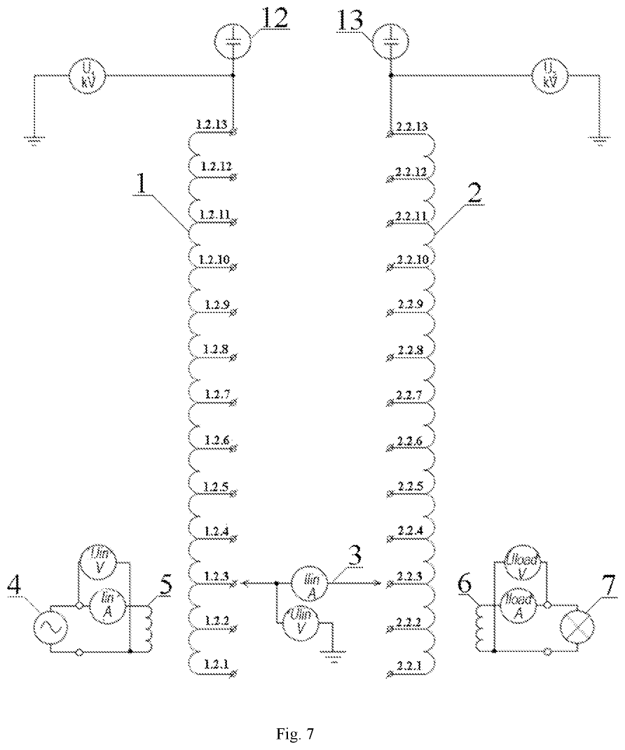

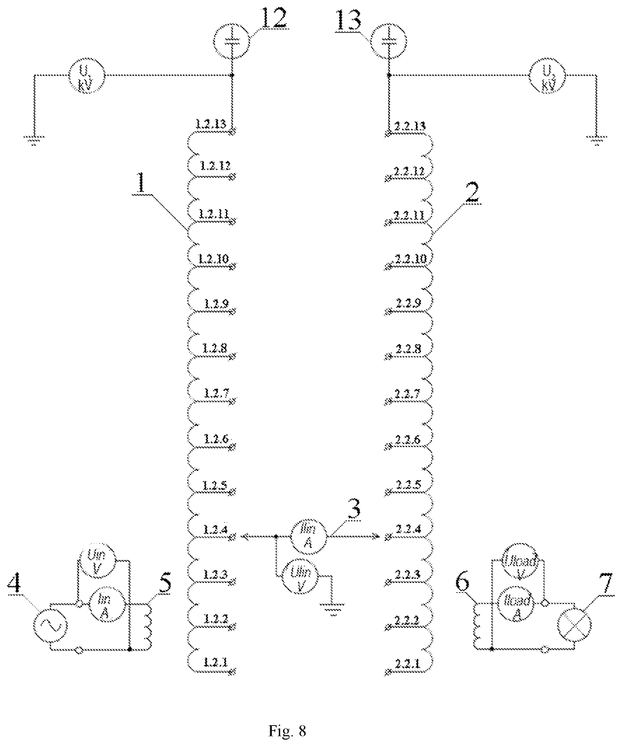

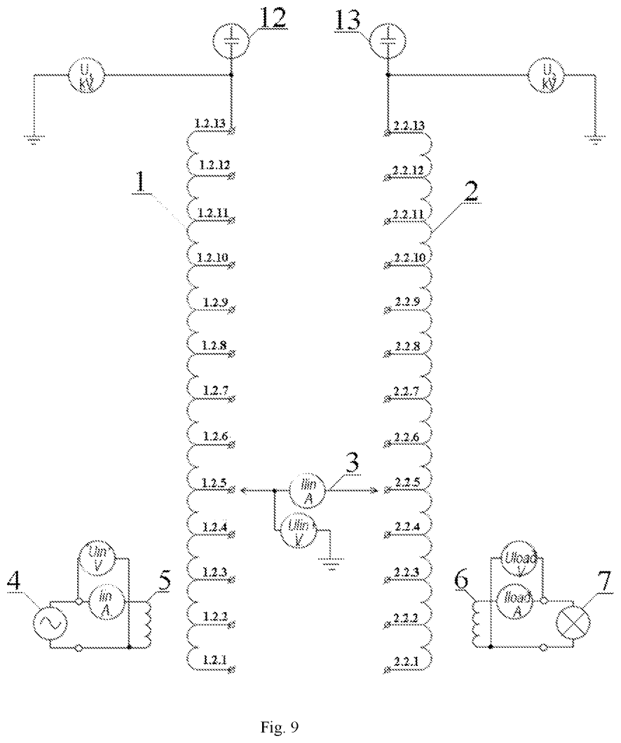

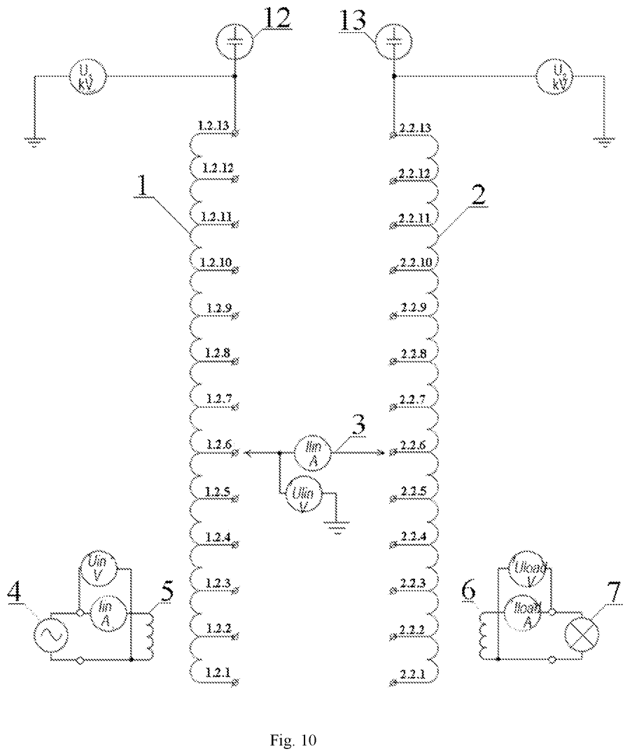

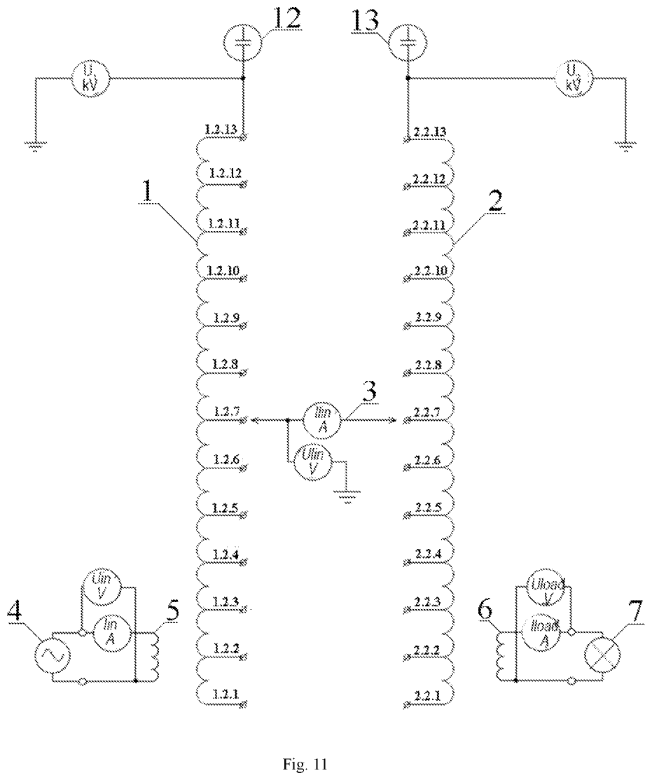

FIG. 5-11 show block diagrams for the embodiments of the system 200 for transmitting electrical energy according to FIG. 2 with control and measurement equipment for testing the technical parameters of the system 200 with the sliding contacts 8, 9 of the transformers not used and with various connections of the electrical energy transmission line 3 to the contact terminals 1.2, which include thirteen contact terminals 1.2.1, 1.2.2, 1.2.3, 1.2.4, 1.2.5, 1.2.6, 1.2.7, 1.2.8, 1.2.9, 1.2.10, 1.2.11, 1.2.12, 1.2.13 of the winding of the transformer 1, and the contact terminals 2.2, which include thirteen contact terminals 2.2.1, 2.2.2, 2.2.3, 2.2.4, 2.2.5, 2.2.6, 2.2.7, 2.2.8, 2.2.9, 2.2.10, 2.2.11, 2.2.12, 2.2.13 of the winding of the transformer 2. In particular, in FIG. 5, the electrical energy transmission line 3 is connected to the contact terminals 1.2.1 and 2.2.1, in FIG. 6, the electrical energy transmission line 3 is connected to the contact terminals 1.2.2 and 2.2.2, in FIG. 7, the electrical energy transmission line 3 is connected to the contact terminals 1.2.3 and 2.2.3, in FIG. 8, the electrical energy transmission line 3 is connected to the contact terminals 1.2.4 and 2.2.4, in FIG. 9, the electrical energy transmission line 3 is connected to the contact terminals 1.2.5 and 2.2.5, in FIG. 10, the electrical energy transmission line 3 is connected to the contact terminals 1.2.6 and 2.2.6, and in FIG. 11, the electrical energy transmission line 3 is connected to the contact terminals 1.2.7 and 2.2.7. The results of tests of the operating or technical parameters with respect to the diagrams of FIG. 5-11 are shown in Table 1; further, the tests used solitary capacitors 12, 13, the capacitances (C1), (C2) of each of which are 150 pF.

TABLE 1
Results of tests with respect to diagrams according to FIG. 5-11

| | F, | Uin, | Iin, | Uload, | Iload, | Ilin, | Ulin, | U1, | U2, | INDICATORS | | |
|---|---|---|---|---|---|---|---|---|---|---|---|---|
| Diagram | kHz | V | A | V | mA | mA | V | kV | kV | P1 | P2 | EFFICIENCY |
| FIG. 5 | 53.70 | 19.30 | 1.42 | 18.90 | 923 | 115 | 266 | 3.7 | 5.2 | 27.41 | 17.4 | 0.64 |
| | 59.20 | 13.20 | 2.30 | 13.10 | 763 | 36 | 850 | 7.7 | 3.5 | 30.36 | 10.0 | 0.33 |
| | 54.00 | 19.30 | 1.42 | 18.90 | 923 | 115 | 266 | 3.7 | 5.2 | 27.41 | 17.4 | 0.64 |
| | 57.00 | 13.20 | 2.30 | 13.10 | 763 | 36 | 850 | 7.7 | 3.5 | 30.36 | 10.0 | 0.33 |
| FIG. 6 | 56.70 | 18.00 | 0.62 | 7.61 | 630 | 60 | 180 | 2.9 | 4.4 | 11.16 | 4.8 | 0.43 |
| | 60.20 | 18.50 | 2.45 | 9.08 | 640 | 33 | 970 | 8.8 | 4.3 | 45.33 | 5.8 | 0.13 |
| FIG. 7 | 59.10 | 28.60 | 0.45 | 3.55 | 450 | 57 | 100 | 6.0 | 3.5 | 12.87 | 1.6 | 0.12 |
| | 61.00 | 16.40 | 2.70 | 5.90 | 537 | 51 | 1022 | 9.2 | 4.2 | 44.28 | 3.2 | 0.07 |
| | 117.70 | 17.00 | 2.70 | 13.10 | 730 | 155 | 180 | 0.1 | 0.1 | 45.90 | 9.6 | 0.21 |
| FIG. 8 | 59.90 | 11.20 | 2.70 | 0.60 | 170 | 77 | 1032 | 6.0 | 2.5 | 30.24 | 0.1 | 0.00 |
| | 84.10 | 17.80 | 1.75 | 10.95 | 663 | 125 | 914 | 1.2 | 0.1 | 31.15 | 7.3 | 0.23 |
| FIG. 9 | 54.40 | 12.60 | 2.70 | 1.45 | 347 | 111 | 1038 | 3.6 | 1.0 | 34.02 | 0.5 | 0.01 |
| | 74.20 | 20.00 | 0.50 | 4.68 | 492 | 80 | 380 | 2.0 | 0.1 | 10.00 | 2.3 | 0.23 |
| FIG. 10 | 46.30 | 15.90 | 1.50 | 4.00 | 363 | 91 | 1300 | 1.5 | 0.2 | 23.85 | 1.5 | 0.06 |
| FIG. 11 | 42.10 | 15.30 | 2.10 | 4.00 | 400 | 98 | 1350 | 1.2 | 0.2 | 32.13 | 1.6 | 0.05 |

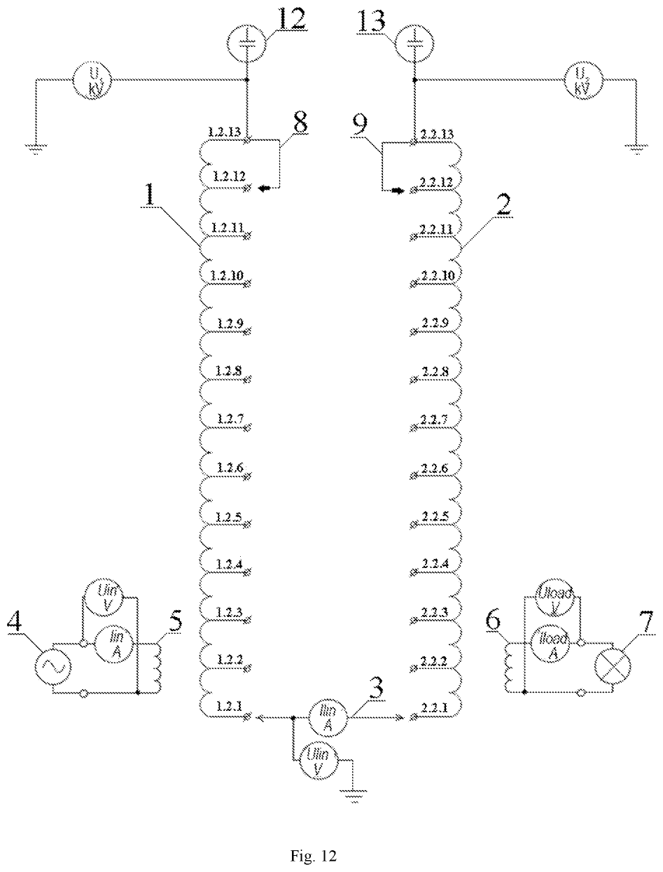

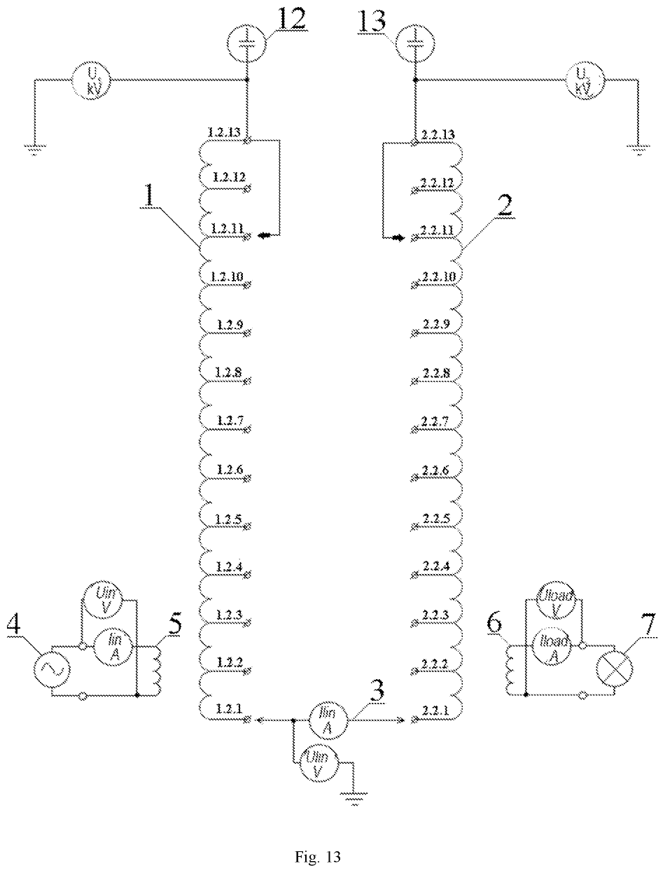

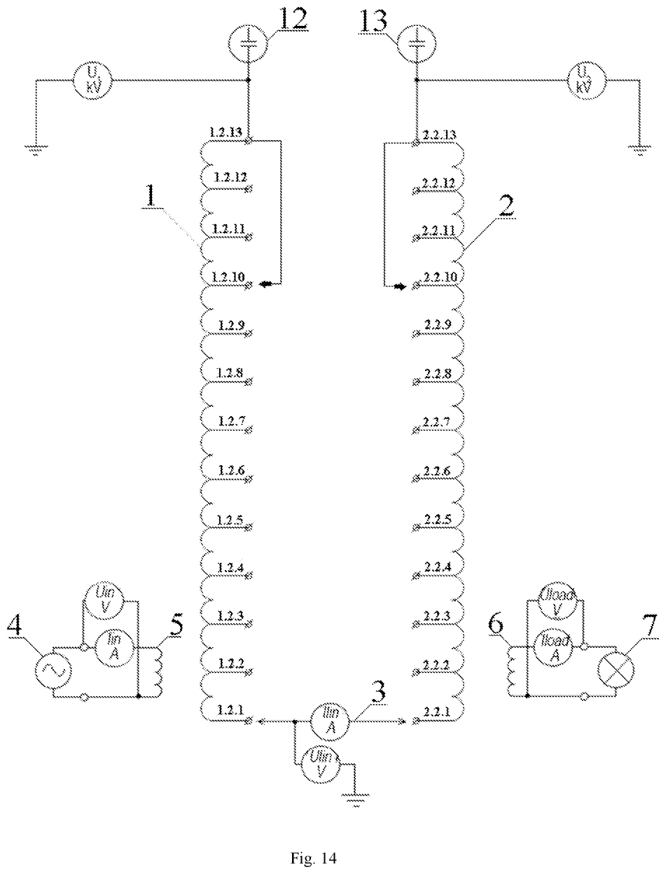

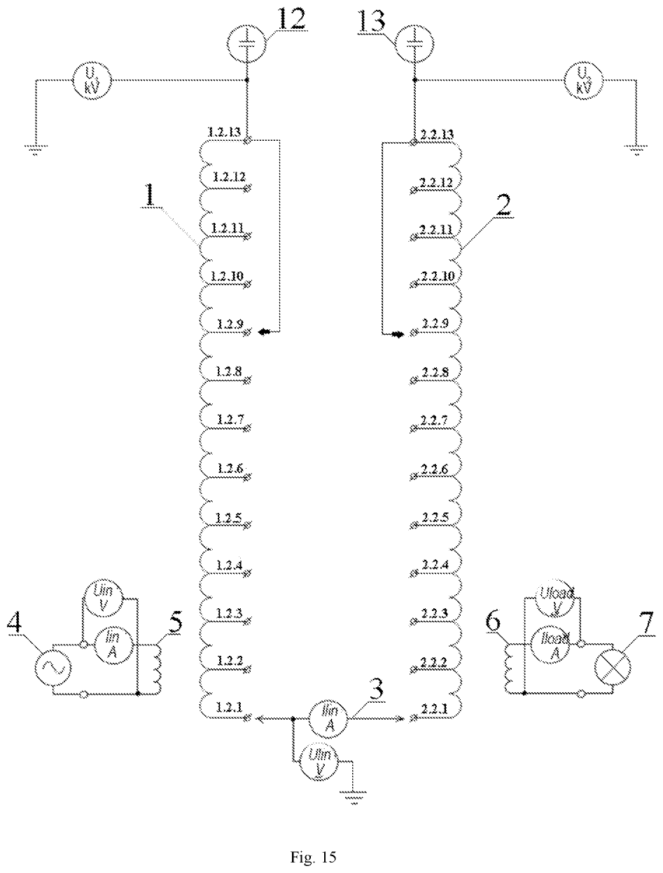

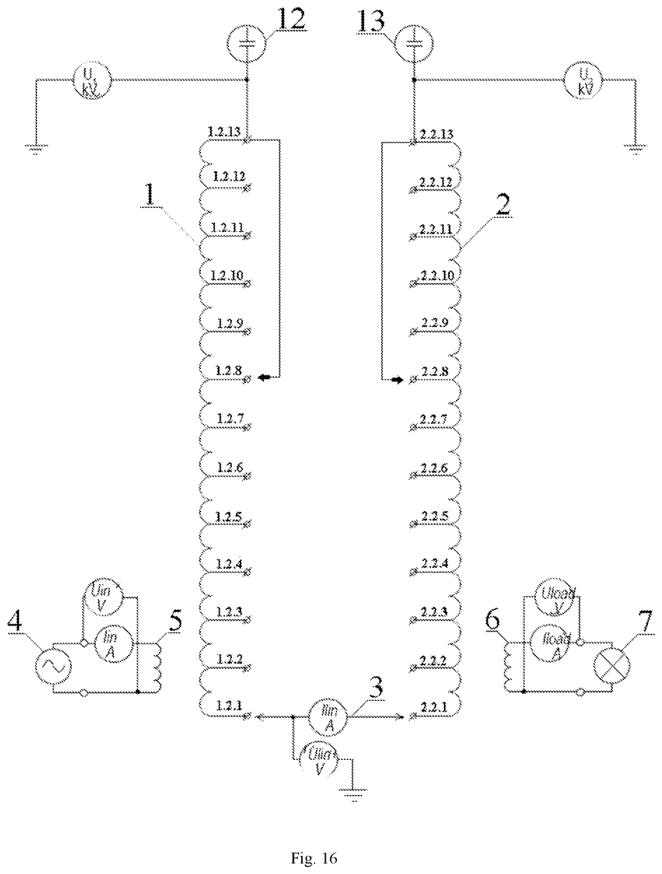

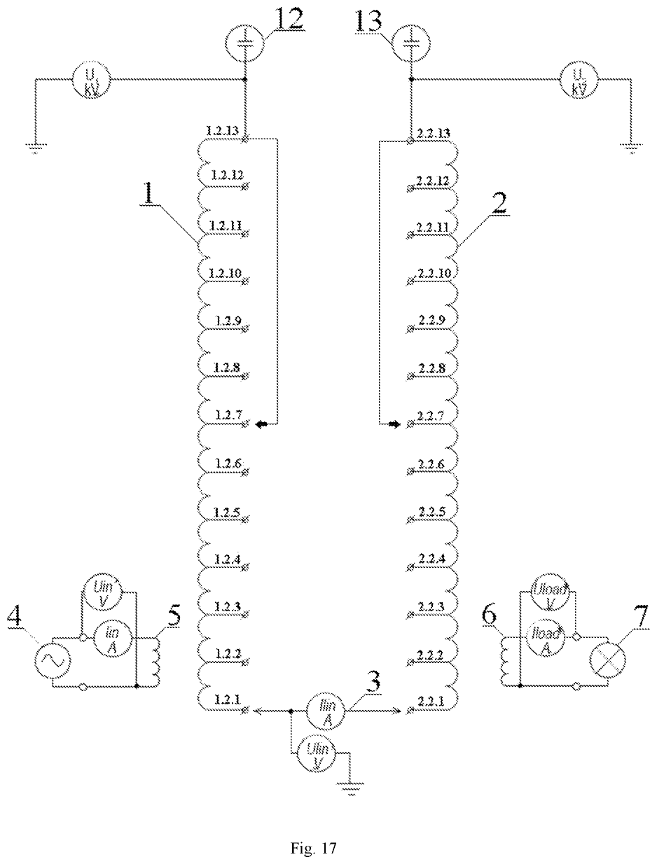

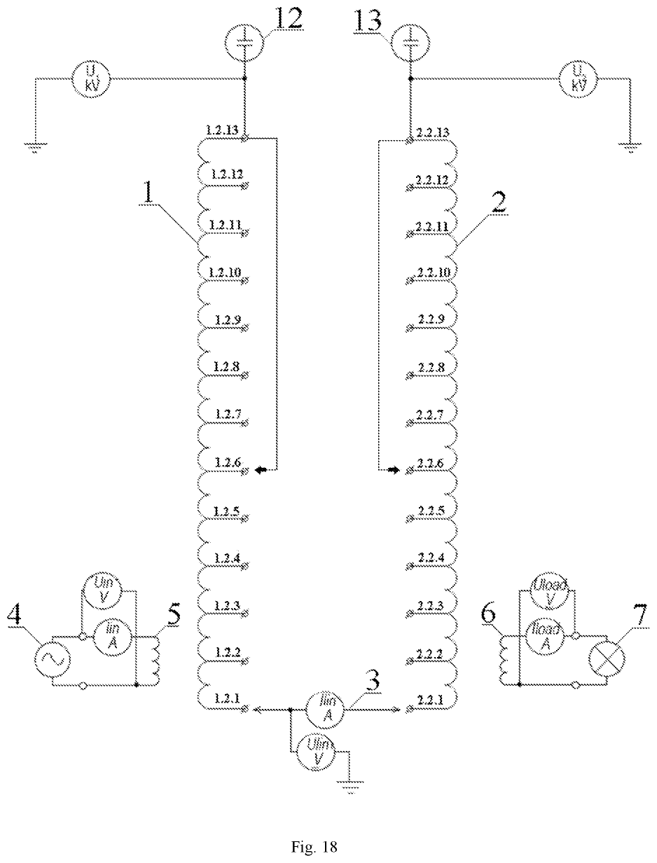

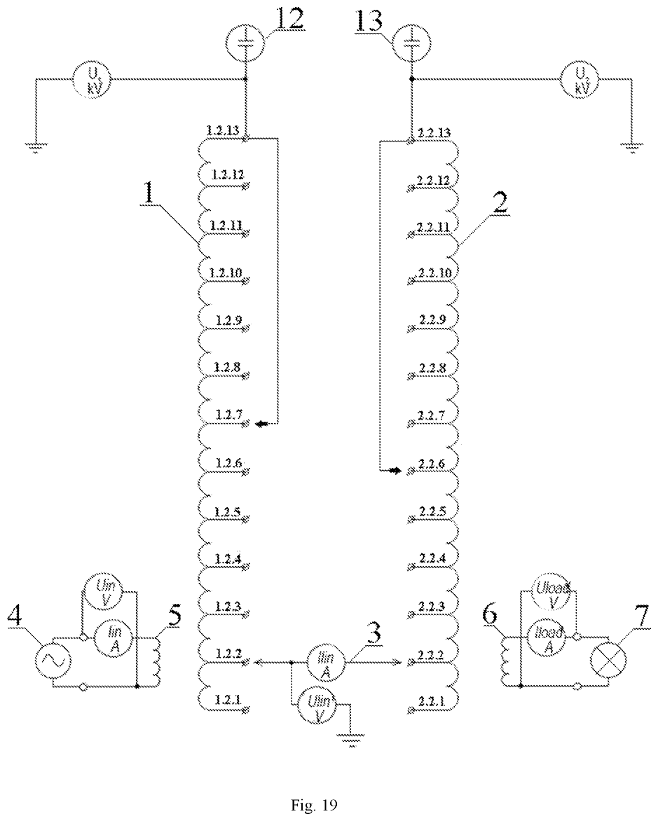

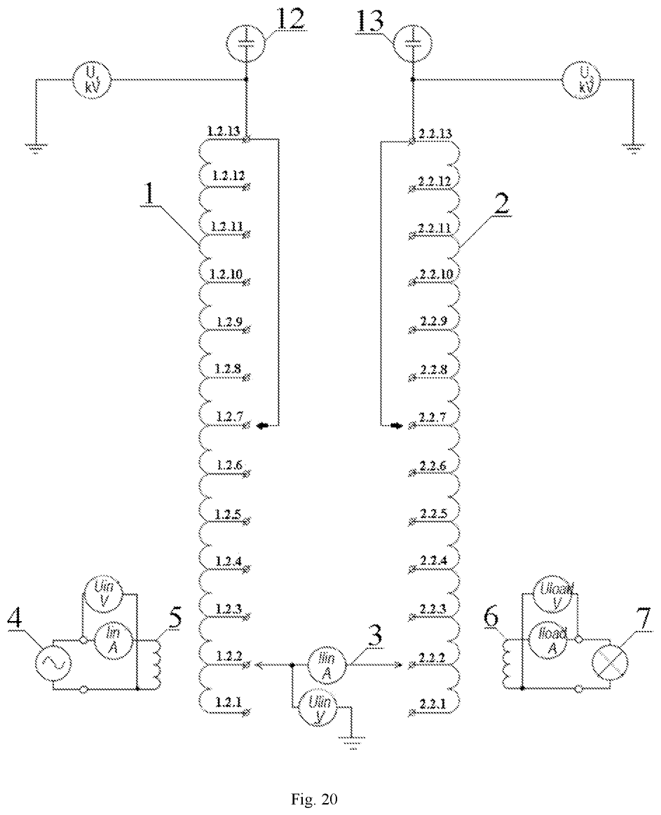

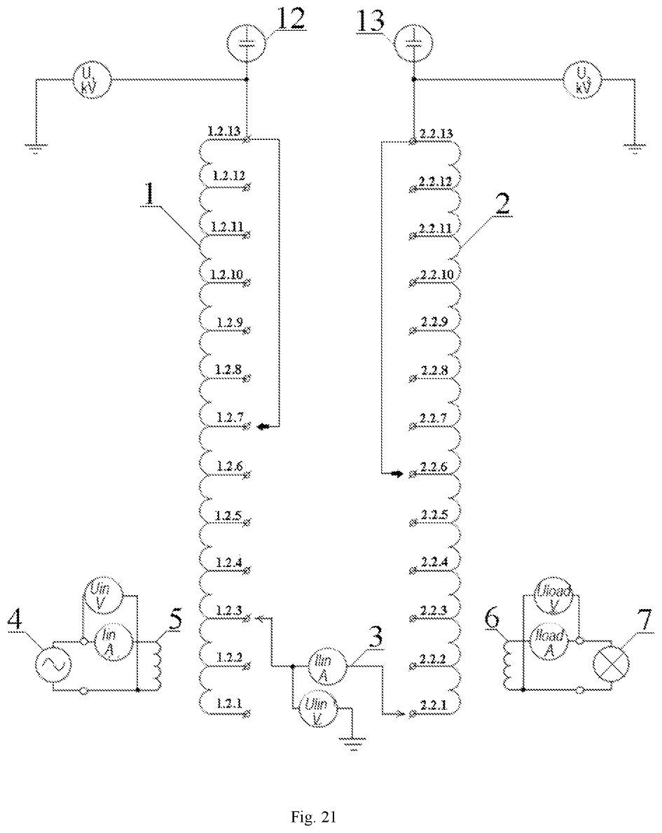

FIG. 12-21 show block diagrams for other embodiments of the system 200 for transmitting electrical energy according to FIG. 2 with test and measurement equipment for testing the technical parameters of the system 200, which further show various connections of the sliding contacts of the transformers 1, 2 to the contact terminals 1.2, 2.2 of the transformers, which, respectively, include thirteen contact terminals 1.2.1, 1.2.2, 1.2.3, 1.2.4, 1.2.5, 1.2.6, 1.2.7, 1.2.8, 1.2.9, 1.2.10, 1.2.11, 1.2.12, 1.2.13 of the winding of the transformer 1 and thirteen contact terminals 2.2.1, 2.2.2, 2.2.3, 2.2.4, 2.2.5, 2.2.6, 2.2.7, 2.2.8, 2.2.9, 2.2.10, 2.2.11, 2.2.12, 2.2.13 of the winding of the transformer 2, and various connections of the electrical energy transmission line 3 to the contact terminals 1.2, 2.2 of the transformers. In particular, in FIG. 12-18, the electrical power transmission line 3 is connected to the contact terminals 1.2.1 and 2.2.1, in FIG. 19-20, the electrical power transmission line 3 is connected to the contact terminals 1.2.2 and 2.2.2, and in FIG. 21, the electrical power transmission line 3 is connected to the contact terminals 1.2.3 and 2.2.1. Furthermore, in FIG. 12, the sliding contacts 8, 9 of the transformers are connected to the contact terminals 1.2.12 and 2.2.12; in FIG. 13, the sliding contacts 8, 9 of the transformers are connected to the contact terminals 1.2.11 and 2.2.11; in FIG. 14, the sliding contacts 8, 9 of the transformers are connected to the contact terminals 1.2.10 and 2.2.10; in FIG. 15, the sliding contacts 8, 9 of the transformers are connected to the contact terminals 1.2.9 and 2.2.9; in FIG. 16, the sliding contacts 8, 9 of the transformers are connected to the contact terminals 1.2.8 and 2.2.8; in FIG. 17, the sliding contacts 8, 9 of the transformers are connected to the contact terminals 1.2.7 and 2.2.7; in FIG. 18, the sliding contacts 8, 9 of the transformers are connected to the contact terminals 1.2.6 and 2.2.6; in FIG. 19, the sliding contact 8 of the transformer is connected to the contact terminal 1.2.7, and the sliding contact 9 of the transformer is connected to the contact terminal 2.2.6; in FIG. 20, the sliding contacts 8, 9 of the transformers are connected to the contact terminals 1.2.7 and 2.2.7; and in FIG. 21, the sliding contact 8 of the transformer is connected to the contact terminal 1.2.7, and the sliding contact 9 of the transformer is connected to the contact terminal 2.2.6. The results of testing the operating or technical parameters with respect to the diagrams of FIG. 12-21 are shown in Table 2; further, the tests used solitary capacitors 12, 13, the capacitances (C1), (C2) of each of which are 150 pF.

TABLE 2
Results of testing with respect to diagrams according to FIG. 12-21

| | F, | Uin, | Iin, | Uload, | Iload, | Ilin, | Ulin, | U1, | U2, | INDICATORS | | |
|---|---|---|---|---|---|---|---|---|---|---|---|---|
| Diagram | kHz | V | A | V | mA | mA | V | kV | kV | P1 | P2 | EFFICIENCY |
| FIG. 12 | 55.00 | 28.30 | 0.70 | 10.50 | 1.44 | 33 | 136 | 3.5 | 2.2 | 19.81 | 15.1 | 0.76 |
| | 59.00 | 23.00 | 1.40 | 15.00 | 1.74 | 37 | 266 | 3.0 | 4.1 | 32.20 | 26.1 | 0.81 |
| FIG. 13 | 56.50 | 28.30 | 0.70 | 10.50 | 1.44 | 33 | 136 | 3.5 | 2.2 | 19.81 | 15.1 | 0.76 |
| | 56.90 | 26.30 | 1.28 | 17.30 | 1.90 | 37 | 266 | 3.8 | 3.9 | 33.66 | 32.9 | 0.98 |
| | 57.40 | 27.50 | 1.10 | 16.20 | 1.83 | 38 | 200 | 4.1 | 4.1 | 30.25 | 29.6 | 0.98 |
| | 58.10 | 23.00 | 1.30 | 16.00 | 1.80 | 35 | 220 | 3.5 | 4.2 | 29.90 | 28.8 | 0.96 |
| | 58.90 | 23.00 | 1.40 | 15.00 | 1.74 | 37 | 266 | 3.0 | 4.1 | 32.20 | 26.1 | 0.81 |
| | 62.60 | 27.00 | 1.40 | 12.00 | 1.55 | 33 | 600 | 6.5 | 4.6 | 37.80 | 18.6 | 0.49 |
| FIG. 14 | 60.90 | 24.50 | 1.30 | 16.80 | 1.82 | 37 | 240 | 3.0 | 3.8 | 31.85 | 30.6 | 0.96 |
| | 65.50 | 19.00 | 1.60 | 11.50 | 1.50 | 34 | 510 | 6.2 | 3.8 | 30.40 | 17.3 | 0.57 |
| FIG. 15 | 64.10 | 22.50 | 1.00 | 13.60 | 1.60 | 36 | 214 | 2.6 | 3.1 | 22.50 | 21.8 | 0.97 |
| | 67.80 | 19.10 | 1.60 | 11.90 | 1.55 | 44 | 385 | 5.6 | 3.4 | 30.56 | 18.4 | 0.60 |
| FIG. 16 | 67.10 | 23.70 | 0.85 | 12.90 | 1.52 | 38 | 163 | 3.0 | 2.5 | 20.15 | 19.6 | 0.97 |
| | 71.00 | 22.20 | 1.45 | 11.70 | 1.54 | 40 | 350 | 4.6 | 3.0 | 32.19 | 18.0 | 0.56 |
| FIG. 17 | 72.40 | 27.60 | 1.05 | 15.20 | 1.78 | 38 | 195 | 2.8 | 2.2 | 28.98 | 27.1 | 0.93 |
| | 77.30 | 20.00 | 1.30 | 11.20 | 1.48 | 49 | 279 | 3.7 | 1.5 | 26.00 | 16.6 | 0.64 |
| FIG. 18 | 77.60 | 30.40 | 0.98 | 15.80 | 1.70 | 49 | 175 | 2.5 | 1.5 | 29.79 | 26.9 | 0.90 |
| | 85.50 | 24.40 | 1.30 | 10.80 | 1.50 | 59 | 251 | 1.2 | 3.6 | 31.72 | 16.2 | 0.51 |
| FIG. 19 | 72.40 | 29.30 | 1.10 | 13.70 | 1.67 | 53 | 169 | 4.4 | 1.0 | 32.23 | 22.9 | 0.71 |
| | 75.30 | 20.70 | 1.65 | 14.40 | 1.72 | 57 | 146 | 3.8 | 1.1 | 34.16 | 24.8 | 0.73 |
| FIG. 20 | 76.20 | 40.00 | 0.55 | 6.80 | 1.28 | 50 | 78 | 4.8 | 3.2 | 22.00 | 8.7 | 0.40 |
| | 77.20 | 37.60 | 0.75 | 10.90 | 1.60 | 42 | 168 | 3.7 | 3.9 | 28.20 | 17.4 | 0.62 |
| FIG. 21 | 72.40 | 43.50 | 0.95 | 9.65 | 1.33 | 62 | 330 | 6.0 | 3.0 | 41.33 | 12.8 | 0.31 |
| | 70.80 | 37.00 | 0.75 | 9.70 | 1.44 | 47 | 199 | 4.0 | 5.4 | 27.75 | 14.0 | 0.50 |

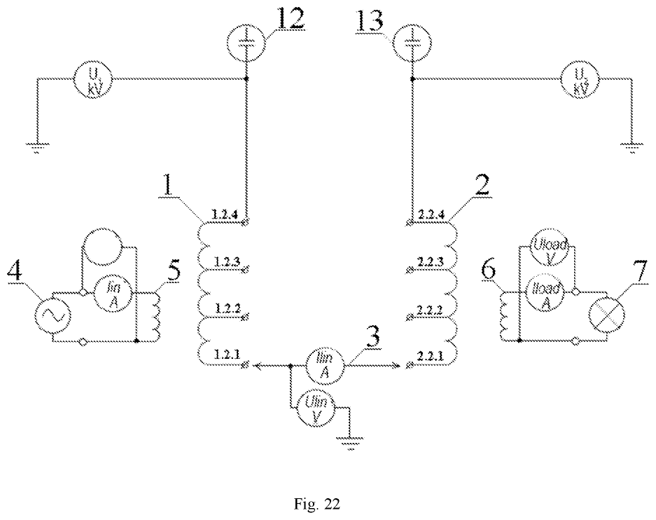

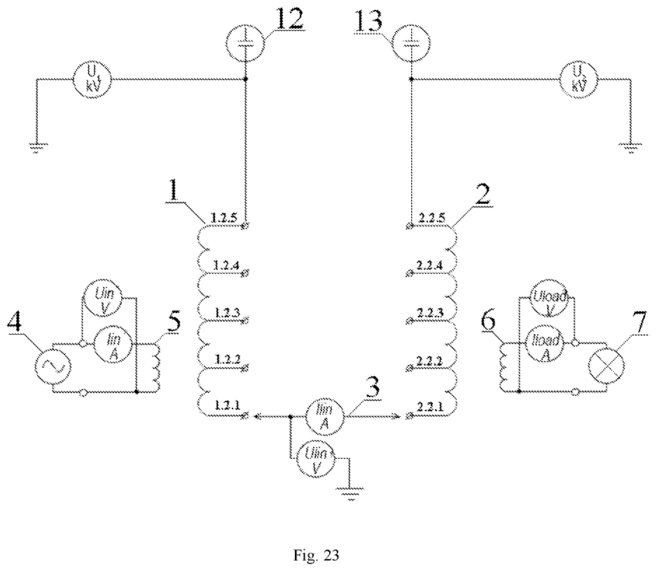

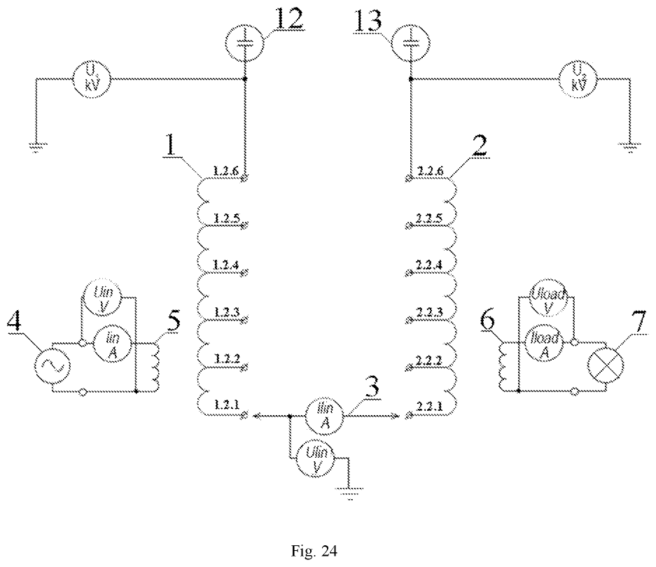

FIG. 22-24 show block diagrams for yet other embodiments of the system 200 for transmitting electrical energy according to FIG. 2 with test and measurement equipment for testing the technical parameters of the system 200, with the sliding contacts of 8, 9 of the transformers not used, with a different number of transformers' turns and with the same connection of the electrical energy transmission line 3 to the contact terminals 1.2, 2.2 of the transformers. In particular, in FIG. 22-24, the electrical energy transmission line 3 is connected to the contact terminals 1.2.1 and 2.2.1. Furthermore, in FIG. 22, the winding of the transformer 1 comprises four contact terminals 1.2, which include the contact terminals 1.2.1, 1.2.2, 1.2.3 and 1.2.4, and the winding of the transformer 2 comprises four contact terminals 2.2, which include the contact terminals 2.2.1, 2.2.2, 2.2.3 and 2.2.4; in FIG. 23, the winding of the transformer 1 comprises five contact terminals 1.2, which include the contact terminals 1.2.1, 1.2.2, 1.2.3, 1.2.4 and 1.2.5, and the winding of the transformer 2 comprises five contact terminals 2.2, which include the contact terminals 2.2.1, 2.2.2, 2.2.3, 2.2.4 and 2.2.5; and in FIG. 24, the winding of the transformer 1 comprises six contact terminals 1.2, which include the contact terminals 1.2.1, 1.2.2, 1.2.3, 1.2.4, 1.2.5 and 1.2.6, and the winding of the transformer 2 comprises six contact terminals 2.2, which include the contact terminals 2.2.1, 2.2.2, 2.2.3, 2.2.4, 2.2.5 and 2.2.6. The results of testing the technical parameters with respect to the diagrams of FIG. 22-24 are shown in Table 3; further, the tests used solitary capacitors 12, 13, the capacitances (C1), (C2) of each of which are 150 pF.

TABLE 3
Results of testing with respect to diagrams according to FIG. 22-24

| | F, | Uin, | Iin, | Uload, | Iload, | Ilin, | Ulin, | U1, | U2, | INDICATORS | | |
|---|---|---|---|---|---|---|---|---|---|---|---|---|
| Diagram | kHz | V | A | V | mA | mA | V | kV | kV | P1 | P2 | EFFICIENCY |
| FIG. 22 | 67.00 | 19.00 | 1.86 | 12.70 | 1.57 | 156 | 179 | 0.1 | 0.1 | 35.34 | 19.9 | 0.56 |
| | 93.00 | 35.00 | 1.00 | 14.70 | 1.65 | 72 | 199 | 0.1 | 0.1 | 35.00 | 24.3 | 0.69 |
| FIG. 23 | 63.00 | 29.50 | 1.80 | 20.00 | 2.00 | 209 | 265 | 2.5 | 1.0 | 53.10 | 40.0 | 0.75 |
| | 88.00 | 32.00 | 0.75 | 11.50 | 1.47 | 63 | 175 | 0.3 | 0.1 | 24.00 | 16.9 | 0.70 |
| FIG. 24 | 60.10 | 32.00 | 2.10 | 20.90 | 2.03 | 226 | 273 | 3.0 | 1.0 | 67.20 | 42.4 | 0.63 |
| | 77.90 | 40.00 | 1.20 | 13.80 | 1.60 | 84 | 183 | 0.3 | 0.2 | 48.00 | 22.1 | 0.46 |

The results of testing with respect to the diagrams of FIG. 5-24, shown in Tables 1-3 above support the authors' conclusions that the subject system for transmitting electrical energy according to any of the embodiments of the present technical solution, which were disclosed herein, provides for more accurate and flexible adjustment of the frequency and operating modes of the system and, therefore, provides for increased efficiency of electrical energy transmission, in particular by reducing electrical losses.

1. A system for transmitting electrical energy comprising:
transmitting and receiving quarter-wave resonant transformers, the quarter-wave winding of each of which is provided with contact terminals,
a source of electrical energy connected to a coupling coil configured to establish a magneto-inductive link with the quarter-wave winding of the transmitting transformer with providing the possibility of exciting resonant oscillations in the quarter-wave winding of the transmitting transformer,
a receiver of electrical energy connected to a coupling coil configured to establish a magneto-inductive link with the quarter-wave winding of the receiving transformer with providing the possibility of receiving electrical energy from the quarter-wave winding of the receiving transformer,
an electrical energy transmission line connecting inter se the low-potential portions of the quarter-wave windings of said receiving and transmitting transformers so as to transmit electrical energy therebetween with providing the possibility of exciting resonant oscillations in the quarter-wave winding of the receiving transformer, wherein
a sliding contact is connected to the high-potential terminal of each of said quarter-wave transformers, the sliding contact being configured to move along the quarter-wave winding of the quarter-wave transformer with providing the possibility of connecting to one of the contact terminals thereof.

2. The system according to claim 1, wherein the source of electrical energy is an alternating current source, and the receiver of electrical energy is a direct current receiver, wherein said receiver is connected to the coupling coil on the side of the receiving quarter-wave transformer by means of an alternating current to direct current converter.

3. The system according to claim 1, wherein the source of electrical energy is a direct current source, and the receiver of electrical energy is an alternating current receiver, said receiver being connected to the coupling coil on the side of the transmitting quarter-wave transformer by means of a direct current to alternating current converter.

4. The system according to claim 1, wherein the source of electrical energy is a direct current source, and the receiver of electrical energy is a direct current receiver, said source being connected to the coupling coil on the side of the transmitting quarter-wave transformer by means of an alternating current to direct current converter, and said receiver being connected to the coupling coil on the side of the receiving quarter-wave transformer by means of an alternating current to direct current converter.

5. The system according to claim 1, wherein the coupling coil on the side of the transmitting quarter-wave transformer has taps for connecting to an electrical energy source and is provided with a slider configured to move along the turns of said coupling coil with providing the possibility of connecting to one of said taps.

6. The system according to claim 1, wherein the coupling coil on the side of the receiving quarter-wave transformer has taps for connecting to an electrical energy receiver and is provided with a slider configured to move along the turns of said coupling coil with providing the possibility of connecting to one of said taps.

7. The system according to claim 1, wherein a further sliding contact configured to move along the turns of the low-potential portion of the quarter-wave winding of the transformer is connected to the low-potential terminal in each of the transmitting and receiving quarter-wave transformers by means of a grounded capacitor.

8. The system according to claim 1, wherein, to connect the high-potential terminal of each of said transmitting and receiving quarter-wave transformers to the corresponding one of the sliding contacts, a corresponding capacitor of predetermined capacitance is used.

9. The system according to claim 1, wherein, to connect the high-potential terminal of each of said transmitting and receiving quarter-wave transformers to the corresponding one of the sliding contacts, a corresponding capacitor of variable capacitance is used.

10. The system according to claim 1, wherein the high-potential terminal in each of said transmitting and receiving quarter-wave transformers is further connected to a solitary capacitor.

11. The system according to claims 1, wherein each of said transmitting and receiving transformers is a quarter-wave resonant Tesla transformer.
